(19) United States
(12) Patent Application Publication
(10) Pub. No.: US 2021/0138673 A1
(43) Pub. Date: May 13, 2021

(54) ELECTRODE CUTTING INSTRUMENT

(71) Applicant: Sion Power Corporation, Tucson, AZ (US)

(72) Inventors: Troy Shannon, Tucson, AZ (US); Urs Schoop, Tucson, AZ (US); David Child, Tucson, AZ (US); Steven M. Kidder, Tucson, AZ (US); Manuel Perez, Tucson, AZ (US)

(73) Assignee: Sion Power Corporation, Tucson, AZ (US)

(21) Appl. No.: 17/089,092

(22) Filed: Nov. 4, 2020

Related U.S. Application Data
(60) Provisional application No. 62/932,475, filed on Nov. 7, 2019.

(51) Int. Cl. B26D 1/00; H01M 10/052; H01M 4/1395; H01M 4/38; H01M 4/04; B26F 1/40; B26D 7/18

(52) U.S. Cl. CPC B26D 1/0006; H01M 10/052; H01M 4/1395; H01M 4/382; B26D 2001/0053; B26F 1/40; B26D 7/1863; B26D 2001/006; H01M 4/04

(57) ABSTRACT

Systems and methods related to cutting electrodes (e.g. lithium metal) and electrode precursors are generally provided. The electrodes or electrode precursors may involve, for example, a lithium metal electrode or a lithium composite electrode, e.g., for use in an electrochemical cell or battery.

### RELATED APPLICATIONS

This application claims priority under 35 U.S.C. § 119(e) to U.S. Provisional Application No. 62/932,475, filed Nov. 7, 2019, and entitled “ELECTRODE CUTTING INSTRUMENT,” which is incorporated herein by reference in its entirety for all purposes.

### TECHNICAL FIELD

Systems and methods for cutting electrodes and electrode precursors, including lithium metal, are generally described.

### SUMMARY

Systems and methods for cutting electrodes and electrode precursors, including lithium metal, are generally described. The subject matter of the present invention involves, in some cases, interrelated products, alternative solutions to a particular problem, and/or a plurality of different uses of one or more systems and/or articles.

In one aspect, a system for cutting a lithium metal layer is described. The system comprises an asymmetric blade, the asymmetric blade comprising a tip, a first edge, and a second edge, as shown in a cross-section of the blade. The system also comprises a first interleaf layer and a second interleaf layer, wherein the lithium metal layer is positioned between the first interleaf layer and the second interleaf layer. The system also comprises a substrate positioned adjacent to the second interleaf layer.

In one embodiment, an electrode precursor is described. The electrode precursor comprises a first interleaf layer, a second interleaf layer, a lithium metal layer having a cross-section, and an optional protective layer adjacent the lithium metal layer. The first and second interleaf layers are in conformal contact with the lithium metal layer and/or the optional protective layer. The first interleaf layer and the second interleaf layer surround a perimeter of the cross-section of the lithium metal layer and optional protective layer.

In another embodiment, a method for cutting a lithium metal layer is provided. The method comprises positioning a layer of the lithium metal between a first interleaf layer and a second interleaf layer; cutting the lithium metal with a blade to form a cut lithium metal piece having a cross-section, wherein the cutting step does not cut through the first interleaf layer. The method also comprises adhering the lithium metal to the first interleaf layer and/or the second interleaf layer such that the first interleaf layer and second interleaf layer surrounds a perimeter of the cross-section of the cut lithium metal piece.

In yet another embodiment, a method for cutting lithium metal is provided. The method comprises positioning the lithium metal between a first interleaf layer and a second interleaf layer; cutting the lithium metal and the first interleaf layer with an asymmetric blade; and adhering the first interleaf layer to the lithium metal. Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1G depict systems and a process for cutting lithium metal, according to one set of embodiments;

FIG. 2A is a schematic diagram of an asymmetric blade for cutting lithium metal, according to some embodiments;

FIG. 2B depicts an asymmetric blade for cutting lithium metal, according to some embodiments;

FIG. 2C depicts an asymmetric blade with more than two cutting edges, according to some embodiments;

FIGS. 2D-2F depict an asymmetric blade with two tips cutting a layer of lithium metal, according to some embodiments;

FIGS. 3A-3B illustrate a system and method for cutting through a first interleaf layer, according to some embodiments;

FIGS. 3C-3D illustrate a system and method for cutting through a first interleaf layer and a protective layer, according to some embodiments;

FIG. 4 is a schematic of an electrode precursor, according to some embodiments;

FIGS. 5A-5G show a system and a process for cutting a layer of lithium metal using two asymmetric blades that may be part of a die, according to one set of embodiments;

FIGS. 6A-6C depict an electrode assembly with a release layer, according to some embodiments; and

FIG. 7 is a photographic image of a die comprising an asymmetric edge for cutting a layer of lithium metal, according to one set of embodiments.

### DETAILED DESCRIPTION

Systems and methods related to cutting electrodes (e.g., lithium metal) and electrode precursors are generally provided. The electrodes or electrode precursors may involve, for example, a lithium metal electrode or a lithium composite electrode, e.g., for use in an electrochemical cell or battery.

Lithium metal may be purchased commercially as a solid suspension in oil or as a foil. It can also be deposited on to a substrate using a variety of techniques, such as vapor deposition, vacuum deposition, or molecular beam epitaxy techniques. In order to fit the dimensions required for its intended use (e.g., as an electrode in an electrochemical cell, a battery), the lithium may require cutting.

However, cutting lithium metal may present several challenges. For example, lithium metal is soft and malleable such that when metallic lithium is cut, it may be sticky and adhere to the cutting instrument (e.g., a knife, a blade) when used to cut metallic elemental lithium. This can present difficulties when cutting multiple pieces of lithium metal in succession because cleaning the blade in between each cut can slow down the process of preparing electrodes and may also dull the blade. Certain existing lithium metal cutting systems attempt to circumvent this issue by positioning the lithium metal between interleafs so that the blade does not directly contact the blade. However, even in such existing systems, lithium may still undesirably adhere to the interleafs, making subsequent removal of the lithium from the interleafs difficult.

Certain existing systems use a symmetric blade to cut lithium metal. However, as described herein, the Inventors have recognized and appreciated that use of an asymmetric blade may provide several advantages over certain existing systems using a symmetric blade. For example, an asymmetric blade may provide a cleaner cut when compared to the use of a symmetric blade. A cleaner cut reduces the amount of lithium metal that may adhere to the blade or to an interleaf layer after cutting. Additionally, a cleaner cut, as provided by an asymmetric blade, may allow more multiple, repeated cuts in succession while reducing the amount of lithium metal waste produced when compared using a symmetric blade.

In some embodiments, an additional advantage is that the asymmetric blade may cut the lithium metal layer without cutting an interleaf layer (e.g., a first interlayer, a second interleaf layer described below) that may be present above and/or below the lithium metal layer. In this way, a layer of lithium metal may be cut without the asymmetric blade making direct contact with lithium metal. As yet another advantage, the asymmetric blade may cause the lithium to adhere temporarily (e.g., stake) to the interleaf layer(s), which provides certain benefits. For example, adhering the cut lithium metal to a bottom interleaf layer (e.g., a second interleaf layer) may advantageously allow for easier removal of a top interleaf layer, while leaving the cut lithium metal (e.g., a lithium electrode) adhered to the bottom interleaf layer. This step may facilitate easier downstream processing when compared to certain existing lithium metal systems, as described in more detail below.

In some embodiments, the asymmetric blade may be configured into a die cast in the shape of an electrode. When the die is pressed down onto a layer of lithium metal positioned in below an interleaf layer (e.g., a top interleaf layer), the layer of lithium metal may be cut in the shape of the electrode while leaving the frame (i.e., the portion of the lithium metal not cut into an electrode) behind. Upon removal of the top interleaf layer from the cut lithium electrode, the cut electrode may be readily removed while leaving behind the frame in place on a bottom interleaf layer.

A system for cutting a lithium metal layer is illustrated in FIG. 1. Specifically, FIG. 1A depicts a cross-section of a system 100, a system for cutting a lithium metal layer, prior to cutting the lithium metal layer. As shown illustratively in this figure, a layer of lithium metal 105 is positioned between a first interleaf layer 120 and a second interleaf layer 125. An asymmetric blade 110 is positioned above the first interleaf layer and may be moved downward toward a substrate 130 along axis 140, which is defined by a line perpendicular to the substrate passing through the tip of the asymmetric blade. The lithium metal layer may be positioned relatively upstream, illustrated by arrow 142, and at least partially positioned downstream as it is being cut, in the direction of the location of arrow 144.

As shown illustratively in FIG. 1B, in some embodiments the asymmetric blade may be lowered such that it crush cuts the lithium metal layer 105 into two pieces of lithium metal, lithium metal piece 105A and lithium metal piece 105B, without cutting the first interleaf layer 120, because the asymmetric blade does not directly contact the lithium metal. Due to the asymmetry of the asymmetric blade, lithium metal piece 105A and lithium metal piece 105B may have adjacent sides (i.e., two adjacent sides created by cutting the layer of lithium metal 105) with distinct slopes and/or distinct angles, as schematically illustrated in the figure. In some embodiments, the first interleaf layer 120 may adhere (e.g., temporarily) to the second interleaf layer 130, as shown illustratively in FIG. 1B. Lithium metal piece 105A and 105B may be moved further downstream (e.g., by a conveyer belt) and lithium metal 105C may be subsequently positioned to be cut by the asymmetric blade, illustrated in FIGS. 1C-1D. The asymmetric blade may then be lowered to cut lithium metal 105C into two pieces, shown illustratively in FIG. 1E.

As used herein, when a layer is referred to as being “on” or “adjacent” another layer, it can be directly on or adjacent the layer, or an intervening layer may also be present. A layer that is “directly on”, “directly adjacent”, “in contact with”, or “in conformal contact with” another layer means that no intervening layer is present. Likewise, a layer that is positioned “between” two layers may be directly between the two layers such that no intervening layer is present, or an intervening layer may be present.

After being moved further downstream, the first interleaf layer 120 may be removed from at least a portion of the cut lithium metal. For example, as shown illustratively in FIG. 1F, lithium metal piece 105B has had first interleaf layer 120 removed, such that the first interleaf layer envelops or surrounds lithium metal piece 105C, but not lithium metal piece 105B. Once the first interleaf layer has been removed from a lithium metal piece 105B, the cut lithium metal piece may be removed from the system, shown illustratively in FIG. 1G.

As described above, an asymmetric blade may be provided for cutting the layer of lithium metal, and the use of such an instrument may provide several advantages, as previously described. Referring now to FIG. 2A, an asymmetric blade 110 may comprise a tip 202, a first side 205, and a second side 210. The tip may be formed by the intersection of a first edge 212 of the blade and a second edge 214 of the blade, which may form an angle with longitudinal axis 140 as shown in a cross-section of the blade. As illustrated in the figure, longitudinal axis 140 is formed by a line that passes through the tip of the asymmetric blade and the line is perpendicular to the substrate 130. In this particular exemplary embodiment shown in FIG. 2A, longitudinal axis 140 is parallel with the first side 205 and the second side 210; however, it should be appreciated that other configurations are also possible, as described in more detail below.

As illustrated in FIG. 2A, first edge 212 forms a first angle 220 with respect to longitudinal axis 140. Similarly, second side 214 forms a second angle 230 with respect to the longitudinal axis. In some embodiments and as pictured in FIG. 2A, the first angle and the second angle are not equal, such that the blade is asymmetric with respect to the first edge and the second edge due to having different angles (e.g., as shown in a cross-section of the blade).

As contrasted with a symmetric blade of certain existing systems, an asymmetric blade is characterized by having at least two cutting edges (e.g., a first edge, a second edge) that join at the tip of the blade at two distinct angles. As is shown and described above in FIGS. 1-2, the angles of the asymmetric blade may be defined along a longitudinal axis passing through the tip of the blade and perpendicular to a substrate positioned below the tip. The first edge may have a first angle formed at the longitudinal axis and a second angle defined by the second edge and the longitudinal axis. The first angle and the second angle are distinct in order to create asymmetry in the blade, and when the blade is used in a crush cut (i.e., a cut that completely penetrates a layer to create two separate pieces), the edges of the cut pieces will have two different slopes reflecting the geometry of the asymmetric blade's first angle and second angle, as illustrated in FIG. 1B. For example, when the first angle is smaller than the second angle, the resulting cut in the layer (e.g., a lithium metal layer) will have a steeper slope along the layer that was cut with the first edge, while the portion of the layer cut with second edge will have a less steep slope. In some embodiments, the less steep edge of the asymmetric blade (i.e., the edge with larger angle) may cause an inner corner of the cut layer of lithium metal to adhere (e.g., stake) to an interleaf layer. That is to say, the less steep edge of the asymmetric blade may cut the lithium metal, in addition to staking the lithium metal to a certain interleaf layer (e.g., the first interleaf layer and/or the second interleaf layer). The asymmetric blade may have an interleaf layer positioned between itself and the lithium metal layer, such that the asymmetric blade does not come into direct contact with the lithium metal layer. In some embodiments, the asymmetric blade may cut the first interleaf layer along with the lithium metal layer. This feature may be useful when preparing lithium electrodes to be used as a component for an electrochemical cell or a battery. For example, when the first interleaf layer comprises a battery separator material, the asymmetric blade may cut the first interleaf layer and the lithium metal layer, where the cut first interleaf layer may serve as a battery separator positioned adjacent the cut lithium electrode (e.g., for incorporation into an electrochemical cell).

In some embodiments, an electrode precursor material is formed using the asymmetric blade. The asymmetric blade may be configured to cut the lithium metal layer while leaving the first interleaf layer uncut by the asymmetric blade. The asymmetric blade may then cause the first interleaf layer and/or the lithium metal to adhere to the second interleaf layer by creating a pinch between the first interleaf layer, the cut lithium metal layer, and the second interleaf layer. This pinch can then be moved downstream and the cut process repeated, to create electrode precursor material. An example of such an electrode precursor is illustrated in FIG. 4 and is described further below.

FIG. 2B depicts another asymmetric blade in accordance with some embodiments. In this figure, first side 205 and second side 210 are horizontal, such that longitudinal axis 140 is no longer parallel with the first side or the second side. However, as illustrated in the figure, the longitudinal axis 140 is still defined by being perpendicular to the substrate and passes through the tip of the asymmetric blade like in FIG. 2A. FIG. 2B illustrates an embodiment that may be particularly advantageous when the asymmetric blade is a part of a die, i.e., for die cutting.

As mentioned elsewhere herein, in some embodiments, an asymmetric blade may have more than one tip. Referring now to FIG. 2C, the asymmetric blade has two tips, first tip 240 and second tip 242, a first side 244, and a second side 246. In addition to a first edge 250 and a second edge 252, the asymmetric blade also comprises a third edge 254 and a fourth edge 256. Longitudinal axis 140 defines a first angle 260 and a second angle 262, while a second longitudinal axis 270 defines a third angle 264 and a fourth angle 266. In such an embodiment, a layer of lithium metal may be cut such that the portion of the layer of lithium between first tip 240 and second tip 242 is cut to have cut edges that are complementary to second edge 252 and third edge 254. In some embodiments, the second angle 262 and the fourth angle 266 are identical, such that a cut edge of lithium metal cut between first tip 240 and second tip 242 have identical slopes. Such embodiments may be advantageous in die cutting, as will be described in more detail below.

In some embodiments, the asymmetric blade may comprise more than two cutting edges, as was described above. Referring now to FIG. 2D, a system for cutting a layer of lithium metal comprises an asymmetric blade 200, where the asymmetric blade comprises two tips and four edges (i.e., two edges for each tip, as shown in a cross-section of the blade). A layer of lithium metal 276 is positioned adjacent to substrate 278 and between the first interleaf layer 272 and the second interleaf layer 274. As shown illustratively in FIGS. 2D-2E, the asymmetric blade may be lowered along longitudinal axis 270 so as to cut the layer of lithium metal 276. In such an embodiment comprising an asymmetric blade with two tips, the layer of lithium metal may be cut into more than two pieces, as shown illustratively in FIG. 2E, where the layer of lithium metal 276 is cut into lithium metal piece 276A, lithium metal piece 276B, and lithium metal piece 276C.

It is noted that lithium metal piece 276B has cut edges that correspond to the angles and/or sides of the asymmetric blade 200 (e.g. the second edge, the third edge, the second angle, the third angle), such that the cut edge of lithium metal piece 276A and lithium metal piece 276C (which are cut by edges not between the first tip and the second tip) are distinct in slope when compared to the cut edges of lithium metal piece 276B (which are cut by edges between the first tip and the second tip). In some embodiments, lithium metal piece 276C is a piece that will not be part of an electrode (e.g., lithium waste) and may be moved downstream and/or removed from the system, illustratively depicted in FIG. 2F. In some embodiments, lithium metal piece 276B may form a component of an electrochemical cell, e.g., as a lithium electrode. In some embodiments, lithium metal piece 276A may proceed downstream and continue to be cut by the asymmetric blade. In some embodiments, the asymmetric blade may stake (i.e., adhere with a relatively high adhesive affinity) or adhere lithium metal piece 276B to the second interleaf layer.

In some embodiments, the asymmetric blade may be configured such that it cuts the first interleaf layer, in addition to the lithium metal layer. Cutting the first interleaf layer in addition to the lithium metal layer leaves a cut layer of the first interleaf layer adjacent to the cut lithium metal layer. When this cut interleaf layer is, for example, a battery separator material, the cut interleaf layer remains adjacent to the lithium metal electrode (e.g., for incorporation into an electrochemical cell). Referring now to FIG. 3A, the asymmetric blade 310 has been positioned such a first angle 314 (e.g., a smaller angle) is now positioned towards upstream position 342 and a second angle 312 (e.g., a larger angle) is now positioned towards downstream position 344. Lithium metal 305 is positioned between a first interleaf layer 320A and a second interleaf layer 330. In some embodiments, this configuration allows the asymmetric blade to cut the first interleaf layer. The asymmetric blade may be lowered towards substrate 340 and may cut the first interleaf layer 320A into first interleaf layer piece 320B and first interleaf layer piece 320C. In addition, lithium metal layer 305 may be cut into lithium metal piece 305A and lithium metal piece 305B. As shown illustratively in FIG. 3C and FIG. 3D, an optional protective layer 350 may be present adjacent (e.g., directly adjacent) the lithium metal layer 305. When the asymmetric blade is lowered towards substrate 340, it may cut the lithium metal, in addition to the optional protective layer 350, forming protective layer 350A and protective layer 350B.

In some embodiments, an electrode precursor may be formed. As shown illustratively in FIG. 4, an envelope-like structure may be formed by the asymmetric blade, such as asymmetric blade 410, whereby the first interleaf layer 410 may conformally contact lithium metal pieces 405A, 405B, and 405C, and the first interleaf layer may also remain adhered to second interleaf layer 420. Together, the first and second interleaf layers may substantially surround or envelope the cut lithium piece(s).

In some embodiments, a system for cutting lithium metal comprises at least two asymmetric blades. The at least two asymmetric blades may be part of a common die. Such an embodiment may advantageously produce a cut piece of lithium metal that has identical cut edges (e.g., edges with the same slope), e.g., around the perimeter of the cut lithium metal. In some embodiments, this configuration may promote adhesion of the lithium metal to an interleaf layer (e.g., a first interleaf layer, a second interleaf layer). For example, FIGS. 5A-5G depict a system for cutting a layer of lithium metal 500, comprising two asymmetric blades. Referring specifically to FIG. 5A, the system for cutting a layer of lithium metal comprises a layer of lithium metal 505 positioned adjacent to substrate 530 and in between first interleaf layer 520 and second interleaf layer 525. Arrow 542 marks an upstream position, while arrow 544 marks a downstream position of the system. A first asymmetric blade 510 comprises a steep edge of the first blade 512 with corresponding first angle 513A and a less steep edge with corresponding second angle 513B. The first asymmetric blade may move towards the substrate 530 along a longitudinal axis 540. A second asymmetric blade 511 comprises a steep edge of the second blade 514 with corresponding third angle 515A and less steep edge with corresponding fourth angle 515B. The asymmetric blade 511 may move towards the substrate along longitudinal axis 541. As shown illustratively in the figure, in some embodiments, the first angle 513A and the third angle 515A are identical. In some embodiments, the second angle 513B and the fourth angle 515B are identical. It should be appreciated that the first, second, third, and/or fourth angles shown in FIGS. 5A-5G may have any suitable values and/or ranges as described herein for such angles. The first asymmetric blade may be located closer to an upstream position, while the second asymmetric blade may be located closer to a downstream position. As pictured in the figure, the two asymmetric blades may be identical, but one blade may be reversed such that the steep edges face towards each other. That is to say, in FIG. 5A, for example, the steep edge of first blade 512 faces the steep edge of second blade 514.

As shown illustratively in FIG. 5B, the first asymmetric blade 510 may be moved towards the substrate along perpendicular longitudinal axis 540 and may cut (e.g., crush cut) the layer of lithium metal, cutting the layer of lithium metal into lithium metal piece 505A and 505B. The second asymmetric blade 511 may then move towards the substrate along perpendicular longitudinal axis 541 and cut lithium metal piece 505A into lithium metal piece 505C and 505D, as shown illustratively in FIG. 5C. The asymmetric blades may be lifted and the lithium metal pieces (e.g., 505B, 505C, 505D) may be moved further downstream, shown illustratively in FIG. 5D. Alternatively, if asymmetric blades are a part of a common die or are otherwise integrally connected to one another, they may move towards the substrate and may cut the lithium metal simultaneously.

In some embodiments, the first interleaf layer may be removed from the layer of lithium metal (e.g., one or more lithium metal pieces). Referring now to FIGS. 5E-5F, the first interleaf layer 520 may be removed from lithium metal piece 505D and/or lithium metal piece 505C. In some embodiments, a lithium metal piece (e.g., lithium metal piece 505D in FIGS. 5C-5F) may not have the desired geometry (e.g., and may be designated as waste lithium) and may be removed from the system. An example of removal is shown in FIG. 5G. In some embodiments, a cut piece of lithium metal may have identical cut edges (e.g., edges with the same steepness), e.g., around the perimeter of the cut piece. For example, in FIG. 5G, cut lithium metal 505C has cut edges that match the steep edge of first blade 512 and the steep edge of second blade 514 in FIG. 5A. In some embodiments, cut lithium piece (e.g., lithium metal piece 505C in FIG. 5G) may be used as part of a lithium metal electrode in an electrochemical cell.

In some embodiments, an electrode assembly or composite electrode may be positioned between the first interleaf layer and the second interleaf layer, and the asymmetric blades described herein may be used to cut not only the electroactive material layer (e.g., lithium metal layer), but also any layers adjacent to the electroactive material layer as part of a stacked assembly. As shown in the illustrative embodiment of FIG. 6A, an electrode assembly 610 includes several layers that are stacked together to form an electrode 612 (e.g., a lithium electrode, an anode, a cathode). For example, electrode 612 may be formed by optionally positioning or depositing one or more release layers 624 on a surface of the second interleaf layer 125, which is adjacent substrate 130 in the figure. As described in more detail below, the release layer serves to subsequently release the electrode from the substrate so that it is not incorporated into the final electrochemical cell. To form the electrode, an electrode component such as a current collector 626 can be positioned or deposited adjacent the release layer and the release layer can be positioned adjacent to the second interleaf layer 125 and/or the substrate. Subsequently, an electroactive material layer 628 (e.g., lithium metal layer) may be positioned or deposited adjacent to current collector 626. In this embodiment, surface 629 of the electroactive layer may be positioned adjacent to the first interleaf layer, while the release layer 624 may be positioned adjacent to the second interleaf and/or the substrate. In this arrangement, the asymmetric blade may cut assembly 612, which includes electroactive layer 628 (e.g., a lithium metal layer). In some embodiments, the first interleaf layer is a battery separator material such that cutting the electroactive layer also results in cutting at least the first interleaf layer, resulting in an electrode assembly that may be suitable for an electrochemical cell or a battery. It should be appreciated that while a release layer is shown in FIG. 6A, in some embodiments it may be absent from the stacked assembly.

After electrode assembly 610 has been formed, the substrate 130 may be released from the electrode through the use of release layer 624. Release layer 624 can be either released along with the substrate so that the release layer is not a part of the final electrode structure, or the release layer may remain a part of the final electrode structure.

The positioning of the release layer during release of the substrate can be varied by tailoring the chemical and/or physical properties of the release layer. For example, if it is desirable for the release layer to be part of the final electrode structure, the release layer may be tailored to have a greater adhesive affinity to current collector 626A relative to its adhesive affinity to carrier substrate 620. On the other hand, if it is desirable for the release layer to not be part of an electrode structure, the release layer may be designed to have a greater adhesive affinity to substrate 130 relative to its adhesive affinity to current collector 626. In the latter case, when a peeling force is applied to carrier substrate 620 (and/or to the electrode), the release layer is released from current collector 626 and remains on substrate 130. In some embodiments, the first interleaf layer 120 may be removed from assembly 610 before or after cutting. In some embodiments, the electrode assembly 612 is fabricated first and then positioned between first and second interleaf layers to be cut by an asymmetric blade as described herein.

In some embodiments, a substrate, release layer, and a current collector may be received in a roll form. The electroactive layer (e.g., the lithium metal layer) may be deposited onto the current collector, together with any optional protective layers. The release layer, current collector, electroactive layer (e.g., lithium metal layer), and optional protective layer may then be released from the substrate. In some embodiments, the release layer remains on the stacked assembly (e.g., on the current collector); however, in other embodiments, the release layer remains on the substrate. The stacked assembly may then be positioned between a first and second interleaf layer and may be cut using a cutting system or blade as described herein.

In some embodiments, substrate 130 is left intact with electrode 612 as a part of electrode assembly 610 after fabrication of the electrode, but before the electrode is incorporated into an electrochemical cell. For instance, electrode assembly 610 may be packaged and shipped to a manufacturer who may then incorporate electrode 612 into an electrochemical cell. In such embodiments, electrode assembly 610 may be inserted into an air and/or a moisture-tight package to prevent or inhibit deterioration and/or contamination of one or more components of the electrode assembly. Allowing the substrate to remain attached to electrode 612 can facilitate handling and transportation of the electrode. For instance, the substrate may be relatively thick and have a relatively high rigidity or stiffness, which can prevent or inhibit electrode 612 from distorting during handling. In such embodiments, the carrier substrate can be removed by the manufacturer before, during, or after assembly of an electrochemical cell.

Although FIG. 6A shows release layer 624 positioned between substrate 620 and current collector 130, in other embodiments, the release layer may be positioned between other components of an electrode. For example, the release layer may be positioned adjacent to surface 629 of electroactive material layer 628, and the substrate may be positioned on the opposite side of the electroactive material layer (not shown). In some such embodiments, an electrode may be fabricated by first positioning one or more release layers onto a substrate. Then, if any protective layer(s) is to be included, the protective layer(s) can be positioned on the one or more release layers. For example, each layer of a multi-layered structure may be positioned separately onto a release layer, or the multi-layered structure may be pre-fabricated and positioned on a release layer at once. The electroactive material layer may then be positioned on the multi-layered structure. (Of course, if a protective layer, such as a multi-layered structure, is not included in the electrode, the electroactive material layer can be positioned directly on the release layer.) Afterwards, any other suitable layers, such as a current collector, may be positioned on the electroactive material layer. To form the electrode, the carrier substrate can be removed from the protective layer(s) (or the electroactive material layer where protective layers are not used) via the release layer. The release layer may remain with the electrode or may be released along with the carrier substrate.

In some embodiments, a release layer has an adhesive function of allowing two components of an electrochemical cell to adhere to one another. One such example is shown in the embodiments illustrated in FIGS. 6B and 6C. For example, as shown illustratively in FIG. 6B, a first electrode portion 612A may include one or more release layers 624A, a current collector 626A, and an electroactive material layer 628A (e.g., a lithium metal layer). Such an electrode portion may be formed after being released from a substrate, e.g., using the method described above in connection with FIG. 6A. Similarly, a second electrode portion 612B may include a release layer 624B, a current collector 626B, and an electroactive material layer 628B. Additional layers can also be deposited onto surfaces 629A and/or 629B of electrode portions 612A and 612B respectively, as described above. As shown in FIGS. 6B-6C, first electrode 612A and 612B may both be positioned between two interleaf layers, such as interleaf layer 120 and interleaf layer 125, and may also be positioned adjacent to a substrate, such as substrate 130.

As shown in the embodiment illustrated in FIGS. 6B-6C, a back-to-back electrode assembly 613, positioned between first interleaf layer 120 and second interleaf layer 130 may be formed by joining electrode portions 612A and 612B, e.g., via release layers 624A and 624B. The electrode portions may be separate, independent units or part of the same unit (e.g., folded over). As illustrated in FIG. 6C, release layers 624A and 624B are facing one another; however, other configurations are also possible. The entire assembly 613 may then be cut with the asymmetric blade. In some embodiments, the asymmetric blade may cut the first interleaf layer and/or the second interleaf layer. In some embodiments, the first interleaf layer may be removed from the assembly.

In some embodiments, the asymmetric blade may be configured along one or more cutting edges of a die as to die cut a layer of lithium metal. A non-limiting example of such a die is depicted in FIG. 7. The use of a die cut may advantageously facilitate successive cuts of a layer of lithium metal where the die is formed in the desired shape (e.g., perimeter) of a lithium electrode, for example, to use in an electrochemical cell or a battery. In such embodiments, the asymmetric blade may cut the layer of lithium metal as to provide an inner portion (e.g., a lithium electrode) and an outer portion (e.g., the frame). In some embodiments, the outer portion may be discarded (e.g., lithium waste), while the inner portion continues downstream and/or is used as a component of an electrochemical cell or a battery.

As mentioned above, the asymmetric blade may be used to cut a layer of lithium metal. An asymmetric blade may comprise a tip, a first edge, and a second edge. The first edge may extend from the tip of the blade by a first angle. The first angle may be defined relative to a longitudinal axis drawn from the tip of the blade perpendicular to the surface of the substrate as shown from a cross-section of the blade. An example of first angle defined relative to the longitudinal axis can be seen in FIG. 1A. In some embodiments, the first angle (e.g., a smaller angle of an asymmetric blade) is less than or equal to 25 degrees (e.g., 15 degrees). For example, in some embodiments, the first angle is less than or equal to 25 degrees, less than or equal to 24 degrees, less than or equal to 23 degrees, less than or equal to 22 degrees, less than or equal to 21 degrees, less than or equal to 20 degrees, less than or equal to 19 degrees, less than or equal to 18 degrees, less than or equal to 17 degrees, less than or equal to 16 degrees, less than or equal to 15 degrees, less than or equal to 14 degrees, less than or equal to 13 degrees, less than or equal to 12 degrees, less than or equal to 11 degrees, less than or equal to 10 degrees, less than or equal to 9 degrees, less than or equal to 8 degrees, less than or equal to 7 degrees, less than or equal to 6 degrees, less than or equal to 5 degrees, less than or equal to 4 degrees, less than or equal to 3 degrees, less than or equal to 2 degrees, less than or equal to 1 degree, or 0 degrees. In some embodiments, the first angle is greater than or equal to 0 degrees, greater than or equal to 1 degree, greater than or equal to 2 degrees, greater than or equal to 3 degrees, greater than or equal to 4 degrees, greater than or equal to 5 degrees, greater than or equal to 6 degrees, greater than or equal to 7 degrees, greater than or equal to 8 degrees, greater than or equal to 9 degrees, greater than or equal to 10 degrees, greater than or equal to 11 degrees, greater than or equal to 12 degrees, greater than or equal to 13 degrees, greater than or equal to 14 degrees, greater than or equal to 15 degrees, greater than or equal to 16 degrees, greater than or equal to 17 degrees, greater than or equal to 18 degrees, greater than or equal to 19 degrees, greater than or equal to 20 degrees, greater than or equal to 21 degrees, greater than or equal to 22 degrees, greater than or equal to 23 degrees, greater than or equal to 24 degrees, or greater than or equal to 25 degrees. Combinations of the above-referenced ranges are also possible (e.g., greater than or equal to 0 degrees and less than or equal to 25 degrees). Other ranges are also possible.

Similarly, a second edge may have a second angle defined relative to the longitudinal axis, an example of which is illustrated in FIG. 1A. In some embodiments, the second angle (e.g., the larger angle of an asymmetric blade) is less than or equal to 70 degrees (e.g., 55 degrees). In some embodiments, the second angle is less than or equal to 70 degrees, less than or equal to 65 degrees, less than or equal to 60 degrees, less than or equal to 55 degrees, less than or equal to 50 degrees, less than or equal to 45 degrees, less than or equal to 40 degrees, less than or equal to 35 degrees, less than or equal to 30 degrees, less than or equal to 25 degrees, less than or equal to 20 degrees, less than or equal to 15 degrees, less than or equal to 10 degrees, or less than or equal to 5 degrees. In some embodiments, the second angle is greater than or equal to 5 degrees, greater than or equal to 10 degrees, greater than or equal to 15 degrees, greater than or equal to 20 degrees, greater than or equal to 25 degrees, greater than or equal to 30 degrees, greater than or equal to 35 degrees, greater than or equal to 40 degrees, greater than or equal to 45 degrees, greater than or equal to 50 degrees, greater than or equal to 55 degrees, greater than or equal to 60 degrees, greater than or equal to 65 degrees, or greater than or equal to 70 degrees. Combinations of the above-referenced ranges are also possible (e.g., greater than or equal to 30 degrees and less than or equal to 70 degrees). Other ranges are also possible.

The first angle and the second angle may be separated by a longitudinal axis that passes through the tip of the blade. In some embodiments, the first angle and the second angle have a sum greater than or equal to 50 degrees and/or less than or equal to 75 degrees (e.g., 55 degrees). In some embodiments, the first angle and the second angle have a sum greater than or equal to 50 degrees, greater than or equal to 55 degrees, greater than or equal to 60 degrees, greater than or equal to 65 degrees, greater than or equal to 70 degrees, or greater than or equal to 75 degrees. In some embodiments, the first angle and the second angle have a sum less than or equal to 75 degrees, less than or equal to 70 degrees, less than or equal to 65 degrees, less than or equal to 60 degrees, less than or equal to 55 degrees, or less than or equal to 50 degrees. Combinations of the above-referenced ranges are also possible (e.g., greater than or equal to 55 degrees and less than or equal to 70 degrees). Other ranges are also possible.

While in some embodiments the asymmetric blade may have one tip, with a first side and a second side, in other embodiments, an additional tip (e.g., a second tip) is present. In some cases, the asymmetric blade may comprise two or more tips, with the second tip having a third side and a fourth side. FIG. 2C illustrates a blade having more than one tip. The use of more than one tip may advantageously provide a configuration where a layer (e.g., lithium metal, the first interleaf layer, the second interleaf layer) can be cut from multiple locations on the lithium metal, such as in a die cut.

In embodiments in which an asymmetric blade or a die (which may include more than one asymmetric blade) includes more than one tip, the blade or die may include a third side and a fourth side, and a third angle and fourth angle. In some embodiments, the third angle is less than or equal to 25 degrees, less than or equal to 24 degrees, less than or equal to 23 degrees, less than or equal to 22 degrees, less than or equal to 21 degrees, less than or equal to 20 degrees, less than or equal to 19 degrees, less than or equal to 18 degrees, less than or equal to 17 degrees, less than or equal to 16 degrees, less than or equal to 15 degrees, less than or equal to 14 degrees, less than or equal to 13 degrees, less than or equal to 12 degrees, less than or equal to 11 degrees, less than or equal to 10 degrees, less than or equal to 9 degrees, less than or equal to 8 degrees, less than or equal to 7 degrees, less than or equal to 6 degrees, less than or equal to 5 degrees, less than or equal to 4 degrees, less than or equal to 3 degrees, less than or equal to 2 degrees, less than or equal to 1 degree, or 0 degrees. In some embodiments, the third angle is greater than or equal to 0 degrees, greater than or equal to 1 degree, greater than or equal to 2 degrees, greater than or equal to 3 degrees, greater than or equal to 4 degrees, greater than or equal to 5 degrees, greater than or equal to 6 degrees, greater than or equal to 7 degrees, greater than or equal to 8 degrees, greater than or equal to 9 degrees, greater than or equal to 10 degrees, greater than or equal to 11 degrees, greater than or equal to 12 degrees, greater than or equal to 13 degrees, greater than or equal to 14 degrees, greater than or equal to 15 degrees, greater than or equal to 16 degrees, greater than or equal to 17 degrees, greater than or equal to 18 degrees, greater than or equal to 19 degrees, greater than or equal to 20 degrees, greater than or equal to 21 degrees, greater than or equal to 22 degrees, greater than or equal to 23 degrees, greater than or equal to 24 degrees, or greater than or equal to 25 degrees. Combinations of the above-referenced ranges are also possible (e.g., greater than or equal to 0 degrees and less than or equal to 25 degrees). Other ranges are also possible.

In some embodiments, the fourth angle is less than or equal to 70 degrees, less than or equal to 65 degrees, less than or equal to 60 degrees, less than or equal to 55 degrees, less than or equal to 50 degrees, less than or equal to 45 degrees, less than or equal to 40 degrees, less than or equal to 35 degrees, less than or equal to 30 degrees, less than or equal to 25 degrees, less than or equal to 20 degrees, less than or equal to 15, less than or equal to 10 degrees, or less than or equal to 5 degrees. In some embodiments, the fourth angle is greater than or equal to 5 degrees, greater than or equal to 10 degrees, greater than or equal to 15 degrees, greater than or equal to 20 degrees, greater than or equal to 25, greater than or equal to 30 degrees, greater than or equal to 35, greater than or equal to 40 degrees, greater than or equal to 45 degrees, greater than or equal to 50 degrees, greater than or equal to 55 degrees, greater than or equal to 60 degrees, greater than or equal to 65 degrees, or greater than or equal to 70 degrees. Combinations of the above-referenced ranges are also possible (e.g., greater than or equal to 30 degrees and less than or equal to 70 degrees). Other ranges are also possible.

The third angle and the fourth angle may be separated by a longitudinal axis that passes through the second tip. In some embodiments, the third angle and the fourth angle have a sum greater than or equal to 50 degrees and less than or equal to 75 degrees (e.g., 55 degrees). In some embodiments, the first angle and the second angle have a sum greater than or equal to 50 degrees, greater than or equal to 55 degrees, greater than or equal to 60 degrees, greater than or equal to 65 degrees, greater than or equal to 70 degrees, or greater than or equal to 75 degrees. In some embodiments, the third angle and the fourth angle have a sum less than or equal to 75 degrees, less than or equal to 70 degrees, less than or equal to 65 degrees, less than or equal to 60 degrees, less than or equal to 55 degrees, or less than or equal to 50 degrees. Combinations of the above-referenced ranges are also possible (e.g., greater than or equal to 55 degrees and less than or equal to 70 degrees). Other ranges are also possible.

The asymmetric blade described herein may have a surface roughness, e.g., a root mean square (RMS) surface roughness, of less than or equal to 1 micron and greater than or equal to 0.5 nm. In some embodiments, a layer has an RMS surface roughness of less than or equal to 1 micron, less than or equal to 500 nm, less than or equal to 100 nm, less than or equal to 50 nm, less than or equal to 25 nm, less than or equal to 10 nm, less than or equal to 5 nm, less than or equal to 1 nm, or less than or equal to 0.5 nm. In some embodiments, a asymmetric blade has an RMS surface roughness of greater than or equal to 0.5 nm, greater than or equal to 1 nm, greater than or equal to 5 nm, greater than or equal to 10 nm, greater than or equal to 25 nm, greater than or equal to 50 nm, greater than or equal to 100 nm, greater than or equal to 500 nm, or greater than or equal to 1 micron. Combinations of the above-referenced range are also possible (e.g. less than or equal to 1 micron and greater than or equal to 0.5 nm). Other ranges are also possible.

In some embodiments, the asymmetric blade is used to cut lithium metal (e.g., a layer of lithium metal). As described above, the lithium metal may be obtained as a solid immersed in oil, or as a foil. It may also be possible to deposit lithium metal onto a surface using a variety of techniques, including vacuum deposition or chemical vapor deposition. Those of ordinary skill in the art will be capable of selecting an appropriate source of lithium metal. Systems and methods described herein may be suitable for other soft metals, such as alkali metals (e.g., Li, Na, K, Cs, etc.).

The thickness of the lithium metal may be selected depending on the size desired, for example, for an electrode in a battery, but generally may be selected to be thick enough to form an electrode, but thin enough to be cut by the asymmetric blade. In some embodiments, a thickness of the lithium metal layer is greater than or equal to 0.5 microns, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 250 microns, greater than or equal to 500 microns, or greater than or equal to 1000 microns. In some embodiments, a thickness of the lithium metal layer is less than or equal to 1000 microns, less than or equal to 500 microns, less than or equal to 250 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 5 microns, less than or equal to 1 micron, or less than or equal to 0.5 microns. Combinations of the above-referenced ranges are also possible (e.g., greater than or equal to 0.5 microns and less than or equal to 20 microns, greater than or equal to 10 microns and less than or equal to 50 microns). Other ranges are also possible.

In some embodiments, the layer of lithium metal has a low surface roughness, e.g., a root mean square (RMS) surface roughness of less than 1 micron, less than 500 nm, less than about 100 nm, less than about 50 nm, less than 25 nm, less than 10 nm, less than 5 nm, less than 1 nm, or less than 0.5 nm. Smooth lithium metal layers can be achieved, in some embodiments, by controlling vacuum deposition of the lithium metal layers. The lithium metal layer may be deposited onto a smooth surface (e.g., a smooth current collector layer) having the same or a similar RMS surface roughness as the desired lithium metal layer. Such and other methods can produce lithium metal layer(s) that are at least 1.5×, 2×, 3×, 4×, 5×, or even 10× smoother than certain commercially-available foils, resulting in substantially uniformly-smooth surfaces.

As mentioned above and elsewhere herein, in some embodiments, an optional protective layer may be present. This optional protective layer may be adjacent to the layer of lithium metal. The optional protective layer(s) may be made from any suitable material capable of acting as a protective layer for the underlying electrode structure (e.g., a lithium metal layer) and that is conductive to the electroactive species. The protective layer may also be referred to as a “single-ion conductive material layer.” In some embodiments, the protective layer is a solid. In some embodiments, the protective layer comprises or may be substantially formed of a non-polymeric material. For example, the protective layer may comprise or may be substantially formed of an inorganic material. Depending on the particular embodiment, the protective layer may be either electrically insulating or electrically conducting. In some embodiments, the protective layer is a ceramic, a glassy-ceramic, or a glass. Additional suitable materials for the protective layer may include, but are not limited to, lithium nitride, lithium silicate, lithium borate, lithium aluminate, lithium phosphate, lithium phosphorus oxynitride, lithium silicosulfide, lithium germanosulfide, lithium oxides (e.g., Li₂O, LiO, LiO₂, LiRO₂, where R is a rare earth metal), lithium lanthanum oxides, lithium titanium oxides, lithium borosulfide, lithium aluminosulfide, lithium phosphosulfide, and combinations thereof.

A protective layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, aerosol deposition, and jet vapor deposition. The technique used may depend on the type of material being deposited, the thickness of the layer, etc.

In some embodiments, a protective layer that includes some porosity can be treated with a polymer or other material such that the pores (e.g., nanopores) of the protective layer may be filled with the polymer. Examples of techniques for forming such structures are described in more detail in U.S. patent application Ser. No. 12/862,528, filed on Aug. 24, 2010, published as U.S. Pub. No. 2011/0177398, entitled “Electrochemical Cell”, which is incorporated herein by reference in its entirety for all purposes.

Additionally or alternatively, in some embodiments, the protective layer may be a polymer layer that is conductive to the electroactive species. Suitable polymers include, but are not limited to, both electrically conducting and electrically insulating ion conduction polymers. Possible electrically conducting polymers include, but are not limited to, poly(acetylene)s, poly(pyrrole)s, poly(thiophene)s, poly(aniline)s, poly(fluorene)s, polynaphthalenes, poly(p-phenylene sulfide)s, and poly(para-phenylene vinylene)s. Possible electrically insulating polymers include, but are not limited to, acrylate, polyethyleneoxide, silicones, and polyvinylchlorides. Polymers described herein for release layers can also be used in a protective layer. In some such embodiments, the polymer(s) is present in a non-swollen state (e.g., as a thin film), such as in configurations in which the protective layer comprising the polymer is separated from the electrolyte by a ceramic, glass or glassy-ceramic layer. The above polymers may be doped with ion conducting salts to provide, or enhance, the desired ion conducting properties. Appropriate salts for lithium based cells include, for example, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂ though other salts may be used for other chemistries. The above materials may be deposited using spin casting, doctor blading, flash evaporation, or any other appropriate deposition technique. In some embodiments, a protective layer is formed of, or includes, a suitable polymeric material listed herein for the release layer, optionally with modified molecular weight, cross-linking density, and/or addition of additives or other components. In embodiments in which more than one protective layer is present, each protective layer may each independently comprise one or more of the above-referenced materials.

In some embodiments, the thickness of the protective layer may be less than or equal to 5 μm, less than or equal to 2 μm, less than or equal to 1.5 μm, less than or equal to 1.4 μm, less than or equal to 1.3 μm, less than or equal to 1.2 μm, less than or equal to 1.1 μm, less than or equal to 1 μm, less than or equal to 0.9 μm, less than or equal to 0.8 μm, less than or equal to 0.7 μm, less than or equal to 0.6 μm, less than or equal to 0.5 μm, less than or equal to 0.4 μm, less than or equal to 0.3 μm, less than or equal to 0.2 μm, less than or equal to 0.1 μm, less than or equal to 50 nm, less than or equal to 30 nm, or any other appropriate thickness. Correspondingly, the thickness of the protective layer may be greater than or equal to 10 nm, greater than or equal to 30 nm, greater than or equal to 50 nm, greater than or equal to 0.1 μm, greater than or equal to 0.2 μm, greater than or equal to 0.3 μm, greater than or equal to 0.4 μm, greater than or equal to 0.6 μm, greater than or equal to 0.8 μm, greater than or equal to 1 μm, greater than or equal to 1.2 μm, greater than or equal to 1.4 μm, greater than or equal to 1.5 μm, or any other appropriate thickness. Combinations of the above are possible (e.g., a thickness of the protective layer may be less than or equal to 2 μm and greater than or equal to 0.1 μm). Other ranges are also possible. In embodiments in which more than one protective layer is present, each protective layer may each independently have a thickness in one or more of the above-referenced ranges.

In some embodiments, a portion of a layer (e.g., a protective layer) and/or a sublayer of a protective layer may be deposited by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, the average ionic conductivity (e.g., lithium ion conductivity) of the protective layer is at least 10⁻⁷ S/cm, at least 10⁻⁶ S/cm, at least 10⁻⁵ S/cm, at least about 10⁴ S/cm, at least 10⁻³ S/cm, at least 10⁻² S/cm, at least 10⁻¹ S/cm, at least 1 S/cm, or at least 10 S/cm. The average ionic conductivity may less than or equal to 20 S/cm, less than or equal to 10 S/cm, or less than or equal to 1 S/cm. Conductivity may be measured at room temperature (e.g., 25 degrees Celsius). In embodiments in which more than one protective layer is present, each protective layer may each independently have an ionic conductivity in one or more of the above-referenced ranges.

While a single protective layer has been depicted in the figures, embodiments in which multiple protective layers, or a multilayer protective layer, are used are also envisioned. Possible multilayer structures can include arrangements of polymer layers and single ion conductive layers as described in more detail in U.S. patent application Ser. No. 12/862,528, filed on Aug. 24, 2010, published as U.S. Pub. No. 2011/0177398, entitled “Electrochemical Cell,” which is incorporated herein by reference in its entirety for all purposes. For example, a multilayer protective layer may include alternating single-ion conductive layer(s) and polymer layer(s), in some embodiments. Other examples and configurations of possible multilayer structures are also described in more detail in U.S. patent application Ser. No. 11/400,781, filed Apr. 6, 2006, published as U. S. Pub. No. 2007-0221265, and entitled, “Rechargeable Lithium/Water, Lithium/Air Batteries” to Affinito et al., which is incorporated herein by reference in its entirety for all purposes.

A single layer or multilayer protective layer can act as a superior permeation barrier by decreasing the direct flow of species to the electroactive material layer, since these species have a tendency to diffuse through defects or open spaces in the layers. Consequently, dendrite formation, self-discharge, and loss of cycle life can be reduced. Another advantage of a protective layer includes the mechanical properties of the structure. For example, where both polymer and inorganic layers are present, the positioning of a polymer layer adjacent an inorganic conductive layer can decrease the tendency of the inorganic conductive layer to crack and can increase the barrier properties of the structure. Thus, these laminates may be more robust towards stress due to handling during the manufacturing process than structures without intervening polymer layers. In addition, a multilayer protective layer can also have an increased tolerance of the volumetric changes that accompany the migration of lithium back and forth from the electroactive material layer during the cycles of discharge and charge of the cell.

As described above, some embodiments comprise an interleaf layer (e.g. a first interleaf layer, a second interleaf layer). The interleaf layer may protect the asymmetric blade from making direct contact with the lithium metal, acting as a barrier that prevents excess lithium from accumulating on the asymmetric blade. For some embodiment, more than one interleaf layer may be provided; for example, two interleaf layers (e.g. a top interleaf layer, a bottom interleaf layer) may be provided whereby the top interleaf layer is positioned adjacent a top surface of the lithium metal layer and the bottom interleaf layer may be positioned on a bottom surface of the lithium metal layer, but above the substrate.

In some case, an interleaf layer (e.g., a second interleaf layer) may be adhered to the lithium metal by the asymmetric blade, as described elsewhere herein. Additional interleaf layers may also be present, e.g., a third interleaf layer or a fourth interleaf layer. It will be understood that any property used to describe an interleaf layer (e.g., a first interleaf layer, a second interleaf layer) may also apply to additional interleaf layers. In some embodiments, it may be advantageous for a first interleaf layer (e.g. the top interleaf layer) to have a thickness less than a thickness of the second interleaf layer (e.g., the bottom interleaf layer). In such an embodiment, a thinner first interleaf layer may facilitate cutting the lithium metal layer and/or the first interleaf layer. However, it is also noted that, in some embodiments, it may be advantageous for a first interleaf layer (e.g., the top interleaf layer) to have a thickness greater than a thickness of a second interleaf layer (e.g., the bottom interleaf layer). For example, in an embodiment where the first interleaf layer comprises a battery separator material, the thickness of the first interleaf layer may be greater than the thickness of the second interleaf layer in order meet the desires of the battery separator thickness. Those of ordinary skill in the art will be capable of selecting interleaf layer thicknesses appropriate for a particular application based on the teachings of this disclosure, such as for cutting lithium electrodes for electrochemical cells or batteries.

In some embodiments, an interleaf layer (e.g. a first interleaf layer, a second interleaf layer, a top interleaf layer, a bottom interleaf layer) may be of a suitable thickness to allow the lithium metal layer to be cut. For example, in some embodiments a thickness of the first interleaf layer is greater than or equal to 5 microns, greater than or equal to 10 microns, greater than or equal to 25 microns, greater than or equal to 50 microns, greater than or equal to 75 microns, greater than or equal to 100 microns, greater than or equal to 150 microns, greater than or equal to 200 microns, or greater than or equal to 250 microns. In some embodiments, a thickness of the first interleaf layer is less than or equal to 250 microns, less than or equal to 200 microns, less than or equal to 150 microns, less than or equal to 100 microns, less than or equal to 75 microns, less than or equal to 50 microns, less than or equal to 25 microns, less than or equal to 10 microns, or less than or equal to 5 microns. Combinations of the above-referenced ranges are also possible (e.g., greater than or equal to 5 microns and less than or equal to 250 microns). Other ranges are also possible.

In some embodiments, the second interleaf layer may have a thickness greater than or equal to 5 microns, greater than or equal to 10 microns, greater than or equal to 25 microns, greater than or equal to 50 microns, greater than or equal to 75 microns, greater than or equal to 100 microns, greater than or equal to 150 microns, greater than or equal to 200 microns, or greater than or equal to 250 microns. In some embodiments, the thickness of the second interleaf layer is less than or equal to 250 microns, less than or equal to 200 microns, less than or equal to 150 microns, less than or equal to 100 microns, less than or equal to 75 microns, less than or equal to 50 microns, less than or equal to 25 microns, less than or equal to 10 microns, or less than or equal to 5 microns. Combinations of the above-referenced ranges are also possible (e.g., greater than or equal to 5 microns and less than or equal to 250 microns). Other ranges are also possible.

As described above, in some embodiments, a stack or an electrode assembly (e.g., an optional protective layer, a lithium metal layer, a current collector, a release layer, etc.) is present between two interleaf layers (e.g., a first interleaf layer, a second interleaf layer). In some embodiments, the asymmetric blade may cut through a stack or an electrode assembly, which may advantageously be used to cut preform electrodes for batteries. In some embodiments, a thickness of a stack and/or an electrode assembly positioned between two interleaf layers is greater than or equal to 0.5 microns, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 200 microns, greater than or equal to 250 microns, greater than or equal to 500 microns, greater than or equal to 750 microns, or greater than or equal to 1000 microns. In some embodiments, a thickness of a stack and/or an electrode assembly positioned between two interleaf layers is less than or equal to 1000 microns, less than or equal to 750 microns, less than or equal to 500 microns, less than or equal to 250 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, or less than or equal to 10 microns. Combinations of the above-referenced ranges are also possible (e.g., greater than or equal to 0.5 microns and less than or equal to 20 microns). Other ranges are also possible.

In some embodiments, the thickness of an interleaf layer (e.g., a first interleaf layer, a second interleaf layer, a top interleaf layer, a bottom interleaf layer) may be selected to have a ratio relative to a thickness of a lithium metal layer. In some embodiments, the ratio of a thickness of an interleaf layer (e.g., a first interleaf layer, a second interleaf layer, a top interleaf layer, a bottom interleaf layer) to thickness of a lithium metal layer is less than or equal to 10:1, less than or equal to 7:1, less than or equal to 5:1, less than or equal to 4:1, less than or equal to 3:1, less than or equal 2:1, or less than or equal to 1:1. In some embodiments, the ratio of a thickness of an interleaf layer (e.g., a first interleaf layer, a second interleaf layer, a top interleaf layer, a bottom interleaf layer) to a thickness of a lithium metal layer is greater than or equal to 1:1, greater than or equal to 2:1, greater than or equal to 3:1, greater than or equal to 4:1, greater than or equal to 5:1, greater than or equal to 7:1, or greater than or equal to 10:1. Combinations of the above-referenced ranges are possible (e.g., greater than or equal to 1:1 and less than or equal to 5:1). Other ranges are also possible.

In some embodiments, the asymmetric blade penetrates a layer of lithium metal so as to crush cut the lithium metal. In some embodiments, the first interleaf layer may contact (e.g., lightly touch) a second interleaf layer when the asymmetric blade cuts the layer of lithium metal. In some embodiments, the first interleaf layer (e.g., top interleaf layer) is not cut during this process, while the lithium metal is crush cut. However, in other embodiments, the first interleaf layer is cut, in addition to the lithium metal layer being crush cut. In some embodiments, a depth of penetration of the asymmetric blade relative to the layer of lithium metal and/or the first interleaf layer may advantageously contribute in determining if the first interleaf layer is cut. Those skilled in the art will be capable of determining an appropriate depth of penetration of the asymmetric blade in cutting or not cutting through the first interleaf based on systems and methods described herein.

By way of example and not limitation, the asymmetric blade may penetrate (e.g., cut) the first interleaf layer (e.g., top interleaf layer) by greater than or equal to 5% of a thickness of the first interleaf layer, greater than or equal to 10% of a thickness of the first interleaf layer, greater than or equal to 20% of the thickness of the first interleaf layer, greater than or equal to 40% of a thickness of the first interleaf layer, greater than or equal to 60% of a thickness of the first interleaf layer, greater than or equal to 80% of a thickness of the first interleaf layer, greater than or equal to 90% of a thickness of the first interleaf layer, greater than or equal to 95% of a thickness of the first interleaf layer, greater than or equal to 99% of a thickness of the first interleaf layer, or 100% of a thickness of the first interleaf layer. In some embodiments, the asymmetric blade may penetrate (e.g., cut) the first interleaf layer (e.g., top interleaf layer) by less than or equal to 100% of a thickness of the first interleaf layer, less than or equal to 99% of a thickness of the first interleaf layer, less than or equal to 95% of a thickness of the first interleaf layer, less than or equal to 90% of a thickness of the first interleaf layer, less than or equal to 80% of a thickness of the first interleaf layer, less than or equal to 60% of a thickness of the first interleaf layer, less than or equal to 40% of a thickness of the first interleaf layer, less than or equal to 20% of a thickness of the first interleaf layer, less than or equal to 10% of a thickness of the first interleaf layer, or less than or equal to 5% of a thickness of the first interleaf layer. Combinations of the above-referenced ranges are also possible (e.g., greater than or equal to 5% of a thickness of the first interleaf layer and less than or equal to 80% of a thickness of the first interleaf layer). Other ranges are possible.

In some embodiments, the asymmetric blade touches the second interleaf layer (e.g., bottom interleaf layer), or may stop before touching the second interleaf layer, but does not cut the second layer during the cutting process.

An interleaf layer (e.g., a first interleaf layer, a second interleaf layer, a top interleaf layer, a bottom interleaf layer) may comprise a polymer. In some embodiments, the polymer comprises at least one of polyethylene, polypropylene, TEFLON®, poly (vinylidene fluoride), polysulfone, polyether sulfone, EVAL®, polystyrene, PVOH, poly (vinyl acetate), poly (methyl acrylate), poly (methyl methacrylate), polyacrylamide, and PET. Other polymers are possible, as this disclosure is not so limited. In embodiments in which more than one interleaf layers are present, each interleaf layer may independently comprise one or more of the above-referenced polymers.

In some embodiments, the interleaf layer(s) (e.g., a first interleaf layer, a second interleaf layer, a top interleaf layer, a bottom interleaf layer) comprises a battery separator material. In other words, the interleaf layer may be formed of a material that can act as a battery separator in an electrochemical cell that incorporates an electrode or electrode precursor structure described herein. In some such embodiments, the asymmetric blade may be configured to cut a first interleaf layer and a second interleaf layer, in addition to cutting the lithium metal layer. This may advantageously provide electrode stacks (i.e., a stack comprising lithium metal and an adjacent battery separator layer, with optional intervening layers between the lithium metal and the battery separator layer) that may be used downstream as a component in an electrochemical cell and/or battery.

The separator generally comprises a polymeric material (e.g., polymeric material that does or does not swell upon exposure to electrolyte). In some embodiments, the separator is located between the electrolyte and an electrode (e.g., between the electrolyte and a first electrode, between the electrolyte and a second electrode, between the electrolyte and an anode, or between the electrolyte and a cathode).

The separator can be configured to inhibit (e.g., prevent) physical contact between two electrodes (e.g., between an anode and a cathode, between a first electrode and a second electrode), which could result in short circuiting of the electrochemical cell. The separator can be configured to be substantially electronically non-conductive, which can inhibit the degree to which the separator causes short circuiting of the electrochemical cell. In certain embodiments, all or portions of the separator can be formed of a material with a bulk electronic resistivity of at least 10⁴, at least 10⁵, at least 10¹⁰, at least 10¹⁵, or at least 10²⁰ Ohm-meters. The bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is at least 10⁻⁷ S/cm, at least 10⁻⁶ S/cm, at least 10⁻⁵ S/cm, at least 10⁻⁴ S/cm, at least 10⁻² S/cm, or at least 10⁻¹ S/cm. In some embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of at least 10⁻⁸ S/cm and less than or equal to 10⁻¹ S/cm). Other values of ionic conductivity are also possible.

The average ionic conductivity of the separator can be determined by employing a conductivity bridge (i.e., an impedance measuring circuit) to measure the average resistivity of the separator at a series of increasing pressures until the average resistivity of the separator does not change as the pressure is increased. This value is considered to be the average resistivity of the separator, and its inverse is considered to be the average conductivity of the separator. The conductivity bridge may be operated at 1 kHz. The pressure may be applied to the separator in 500 kg/cm² increments by two copper cylinders positioned on opposite sides of the separator that are capable of applying a pressure to the separator of at least 3 tons/cm². The average ionic conductivity may be measured at room temperature (e.g., 25° C.).

In some embodiments, the separator can be a solid. The separator may be sufficiently porous such that it allows an electrolyte solvent to pass through it. In some embodiments, the separator does not substantially include a solvent (e.g., it may be unlike a gel that comprises solvent throughout its bulk), except for solvent that may pass through or reside in the pores of the separator. In other embodiments, a separator may be in the form of a gel.

A separator can comprise a variety of materials. The separator may comprise one or more polymers (e.g., it may be polymeric, it may be formed of one or more polymers), and/or may comprise an inorganic material (e.g., it may be inorganic, it may be formed of one or more inorganic materials). Examples of suitable polymeric separator materials include, but are not limited to, polyolefins (e.g., polyethylenes, poly(butene-1), poly(n-pentene-2), polypropylene, polytetrafluoroethylene); polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)); polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcyanoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

In some embodiments, a layer(s) (e.g. a first interleaf layer, a second interleaf layer, a top interleaf layer, a bottom interleaf layer) has a surface roughness, e.g., a root mean square (RMS) surface roughness, of less than or equal to 1 micron and greater than or equal to 0.5 nm. In some embodiments, a layer has an RMS surface roughness of less than or equal to 1 micron, less than or equal to 500 nm, less than or equal to 100 nm, less than or equal to 50 nm, less than or equal to 25 nm, less than or equal to 10 nm, less than or equal to 5 nm, less than or equal to 1 nm, or less than or equal to 0.5 nm. In some embodiments, a layer has an RMS surface roughness of greater than or equal to 0.5 nm, greater than or equal to 1 nm, greater than or equal to 5 nm, greater than or equal to 10 nm, greater than or equal to 25 nm, greater than or equal to 50 nm, greater than or equal to 100 nm, greater than or equal to 500 nm, or greater than or equal to 1 micron. Combinations of the above-referenced range are also possible (e.g., less than or equal to 1 micron and greater than or equal to 0.5 nm). Other ranges are possible.

In some embodiments, an interleaf layer and/or a release layer may include one or more crosslinking agents. A crosslinking agent is a molecule with a reactive portion(s) designed to interact with functional groups on the polymer chains in a manner that will form a crosslinking bond between one or more polymer chains. Examples of crosslinking agents that can crosslink polymeric materials used for release layers and/or adhesion promoters described herein include, but are not limited to: polyamide-epichlorohydrin (polycup 172); aldehydes (e.g., formaldehyde and urea-formaldehyde); dialdehydes (e.g., glyoxal glutaraldehyde, and hydroxyadipaldehyde); acrylates (e.g., ethylene glycol diacrylate, di(ethylene glycol) diacrylate, tetra(ethylene glycol) diacrylate, methacrylates, ethelyne glycol dimethacrylate, di(ethylene glycol) dimethacrylate, tri(ethylene glycol) dimethacrylate); amides (e.g., N,N′-methylenebisacrylamide, N,N′-methylenebisacrylamide, N,N′-(1,2-dihydroxyethylene)bisacrylamide, N-(1-hydroxy-2,2-dimethoxyethyl)acrylamide); silanes (e.g., methyltrimethoxysilane, methyltriethoxysilane, tetramethoxysilane (TMOS), tetraethoxysilane (TEOS), tetrapropoxysilane, methyltris(methylethyldetoxime)silane, methyltris(acetoxime)silane, methyltris(methylisobutylketoxime)silane, dimethyldi(methylethyldetoxime)silane, trimethyl(methylethylketoxime)silane, vinyltris(methylethylketoxime)silane, methylvinyldi(mtheylethylketoxime)silane, methylvinyldi(cyclohexaneoneoxxime)silane, vinyltris(mtehylisobutylketoxime)silane, methyltriacetoxysilane, tetraacetoxysilane, and phenyltris(methylethylketoxime)silane); divinylbenzene; melamine; zirconium ammonium carbonate; dicyclohexylcarbodiimide/dimethylaminopyridine (DCC/DMAP); 2-chloropyridinium ion; 1-hydroxycyclohexylphenyl ketone; acetophenon dimethylketal; benzoylmethyl ether; aryl triflourovinyl ethers; benzocyclobutenes; phenolic resins (e.g., condensates of phenol with formaldehyde and lower alcohols, such as methanol, ethanol, butanol, and isobutanol), epoxides; melamine resins (e.g., condensates of melamine with formaldehyde and lower alcohols, such as methanol, ethanol, butanol, and isobutanol); polyisocyanates; dialdehydes; and other crosslinking agents known to those of ordinary skill in the art.

In embodiments including a crosslinked polymeric material and a crosslinking agent, the weight ratio of the polymeric material to the crosslinking agent may vary for a variety of reasons including, but not limited to, the functional-group content of the polymer, its molecular weight, the reactivity and functionality of the crosslinking agent, the desired rate of crosslinking, the degree of stiffness/hardness desired in the polymeric material, and the temperature at which the crosslinking reaction may occur. Non-limiting examples of ranges of weight ratios between the polymeric material and the crosslinking agent include from 100:1 to 50:1, from 20:1 to 1:1, from 10:1 to 2:1, and from 8:1 to 4:1.

The adhesive strength between two layers described herein, such as between a lithium metal layer and an interleaf layer (e.g., a first interleaf layer, a second interleaf layer), between a protective layer and an interleaf layer (e.g., a first interleaf layer, a second interleaf layer), between a current collector and an interleaf layer (e.g., a first interleaf layer, a second interleaf layer), and/or between an interleaf layer and a substrate, can be tailored as desired. To determine relative adhesion strength between two layers, a tape test can be performed. Briefly, the tape test utilizes pressure-sensitive tape to qualitatively assess the adhesion between a first layer (e.g., an interleaf layer) and a second layer (e.g., a lithium metal layer). In such a test, an X-cut can be made through the first layer to the second layer. Pressure-sensitive tape can be applied over the cut area and removed. If the first layer stays on the second layer, adhesion is good. If the first layer comes off with the strip of tape, adhesion is poor. The tape test may be performed according to the standard ASTM D3359-02. In some embodiments, a strength of adhesion between a first layer (e.g., an interleaf layer) and a second layer (e.g., a lithium metal layer, a current collector, a protective layer, a substrate) passes the tape test according to the standard ASTM D3359-02, meaning the second layer does not delaminate from the first layer during the test. In some embodiments, the tape test is performed after the two layers have been included in a cell, such as a lithium-ion cell or any other appropriate cell described herein, that has been cycled at least 5 times, at least 10 times, at least 15 times, at least 20 times, at least 50 times, or at least 100 times, and the two layers pass the tape test after being removed from the cell (e.g., the first layer does not delaminate from the second layer during the test).

The peel test may include measuring the adhesiveness or force required to remove a first layer (e.g., an interleaf layer) from a unit area of a surface of a second layer (e.g., a lithium metal layer), which can be measured in N/m, using a tensile testing apparatus or another suitable apparatus. Such experiments can optionally be performed in the presence of a solvent (e.g., an electrolyte) or other components to determine the influence of the solvent and/or components on adhesion.

In some embodiments, the strength of adhesion between two layers (e.g., a first layer such as an interleaf layer and a second layer such as a lithium metal layer, a protective layer, a current collector, a substrate) may range, for example, between 100 N/m to 2000 N/m. In some embodiments, the strength of adhesion may be at least 50 N/m, at least 100 N/m, at least 200 N/m, at least 350 N/m, at least 500 N/m, at least 700 N/m, at least 900 N/m, at least 1000 N/m, at least 1200 N/m, at least 1400 N/m, at least 1600 N/m, or at least 1800 N/m. In some embodiments, the strength of adhesion may be less than or equal to 2000 N/m, less than or equal to 1500 N/m, less than or equal to 1000 N/m, less than or equal to 900 N/m, less than or equal to 700 N/m, less than or equal to 500 N/m, less than or equal to 350 N/m, less than or equal to 200 N/m, less than or equal to 100 N/m, or less than or equal to 50 N/m. Combinations of the above-referenced ranges are also possible (e.g., at least 100 N/m and less than or equal to 700 N/m). Other strengths of adhesion are also possible.

In some embodiments, the lithium metal layer may be deposited using physical vapor deposition, sputtering, chemical deposition, electrochemical deposition, thermal evaporation, jet vapor deposition, laser ablation, or any other appropriate method. In an alternative embodiment, the lithium metal layer is deposited on a protective layer by bonding the lithium metal layer to the protective layer. In such an embodiment, a temporary bonding layer might be deposited onto the protective layer prior to bonding the lithium metal layer, or the lithium metal layer might bond directly to the protective layer. In some embodiments, the temporary bonding layer may form an alloy with the lithium metal layer upon subsequent cycling of the electrode structure in an electrochemical cell. For example, silver and/or other metals that can alloy with lithium can be used in some embodiments. In embodiments in which the protective layer has already been formed or deposited, it may be unnecessary to maintain a low surface roughness on the exposed surface of the lithium metal layer. However, embodiments in which the surface roughness of lithium metal layer is controlled are also envisioned.

In some embodiments in which a release layer is present, the thickness of the release layer may be between greater than or equal to 0.001 microns and less than or equal to 50 microns. In some embodiments, a release layer has a thickness of greater than or equal to 0.001 microns, greater than or equal to 1 micron, greater than or equal to 2 microns, greater than or equal to 3 microns, greater than or equal to 5 microns, greater than or equal to 10 microns, greater than or equal to 20 microns, or greater than or equal to 50 microns. In some embodiments, the thickness of a release layer is less than or equal to 50 microns, less than or equal to 20 microns, less than or equal to 10 microns, less than or equal to 5 microns, less than or equal to 3 microns, less than or equal to 2 microns, less than or equal to 1 micron, or less than or equal to 0.001 microns. Combinations of the above-referenced ranges are possible (e.g., greater than or equal to 2 microns and less than or equal to 20 microns). Other ranges are possible. In embodiments in which more than one release layers are present, each release layer may independently have a thickness in one or more of the above-referenced ranges.

In some embodiments, a release layer comprises a crosslinkable polymers. Non-limiting examples of crosslinkable polymers include: polyvinyl alcohol, polyvinylbutryl, polyvinylpyridyl, polyvinyl pyrrolidone, polyvinyl acetate, acrylonitrile butadiene styrene (ABS), ethylene-propylene rubbers (EPDM), EPR, chlorinated polyethylene (CPE), ethelynebisacrylamide (EBA), acrylates (e.g., alkyl acrylates, glycol acrylates, polyglycol acrylates, ethylene ethyl acrylate (EEA)), hydrogenated nitrile butadiene rubber (HNBR), natural rubber, nitrile butadiene rubber (NBR), certain fluoropolymers, silicone rubber, polyisoprene, ethylene vinyl acetate (EVA), chlorosulfonyl rubber, flourinated poly(arylene ether) (FPAE), polyether ketones, polysulfones, polyether imides, diepoxides, diisocyanates, diisothiocyanates, formaldehyde resins, amino resins, polyurethanes, unsaturated polyethers, polyglycol vinyl ethers, polyglycol divinyl ethers, copolymers thereof, and those described in U.S. Pat. No. 6,183,901 to Ying et al. of the common assignee for protective coating layers for separator layers. In embodiments in which more than one release layers are present, each release layer may independently comprise one or more of the above-referenced polymers.

As described above, lithium metal may be adhered (i.e., staked) to an interleaf layer. The degree of adherence, e.g., adhesion strength, may be varied depending on the degree of adhesion desired, and have one or more ranges described herein. In some embodiments, the asymmetric blade may be configured to advantageously stake (i.e., adhere with a relatively high adhesive affinity) an interleaf layer to the lithium metal. By way of example and not limitation, the asymmetric blade may both cut and stake (e.g., relatively strongly adhere) a cut piece of lithium metal to the second interleaf layer (e.g., bottom interleaf layer), while facilitating relatively easy removal of the first interleaf layer (e.g., top interleaf layer) from the cut lithium metal. In other words, the strength of adhesion of the first interleaf layer (e.g., top interleaf layer) to an electrode component (e.g., lithium metal layer, optional protective layer) may be less than the strength of adhesion of the second interleaf layer (e.g., bottom interleaf layer) to the an electrode component (e.g., lithium metal layer, current collector). In some embodiments, staking or adhering the lithium metal to the second interleaf layer may allow for removal of the first interlayer while the lithium metal remains staked (i.e., adhered with a relatively high adhesive affinity) to the second interleaf layer. In some embodiments, the asymmetric blade may stake (i.e., adhere with a relatively high adhesive affinity) the lithium metal to the first interleaf layer and the second interleaf layer. In some embodiment still, the asymmetric layer may cut the lithium metal without adhering the first interleaf layer nor the second interleaf layer. The degree of staking or adhesion between layers may be controlled, in some embodiments, by choosing the appropriate materials for the interleaf layer(s) and/or appropriate angles of the edges of the asymmetric blade. Measurement of the adhesion strength is described elsewhere herein.

As described herein, in some embodiments, the angle(s) of the asymmetric blade may determine, at least in part, if the layer of lithium metal is adhered to an interleaf (e.g., a second (e.g., bottom) interleaf layer). As described above, if the first angle of the first side or edge is larger (e.g., less steep) than the second angle of the second side or edge, then the cut edge of the layer of lithium metal cut with the first side will be relatively less steep, while the cut edge of the layer of lithium metal cut by the second will be relatively more steep. In some embodiments, the less steep cut edge of the layer of lithium metal (e.g., a piece of lithium metal) will adhere or stake (i.e., adhere with a relatively high adhesive affinity) to the second (e.g., bottom) interleaf layer (i.e., will have a relatively high adhesive affinity to the second interleaf layer). Meanwhile, the more steep cut edge of the layer of lithium metal with adhere to the first (e.g., top) interleaf layer with a relatively low adhesive affinity, which may advantageously promote facile removal of the first interleaf layer relative to the second interleaf layer. In some embodiments, the arrangement of the blade may be reversed, such that the cut layer of lithium metal is staked (i.e., will have a relatively high adhesive affinity to the second (e.g., bottom) interleaf layer) and/or may have a relatively high adhesive affinity to the first (e.g., top) interleaf layer where it is desirable to have the first interleaf layer adhered to the lithium metal (or a protective layer on the lithium metal).

In some embodiments, the first interleaf layer may be removed from the lithium metal (e.g., a cut piece of lithium metal, after staking to the second interleaf layer). Removal of the first interleaf may be accomplished by any suitable method, including by use of vacuum. In some cases, a cut piece of lithium may be removed after being cut and moving downstream and after the first interleaf has been removed from the cut piece of lithium. Removal of the cut piece of lithium may be accomplished using a vacuum apparatus or any other suitable method for removing the lithium metal from the second interleaf layer.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for cutting a lithium metal layer, comprising:
an asymmetric blade, the asymmetric blade comprising a tip, a first edge, and a second edge, as shown in a cross-section of the blade;
a first interleaf layer;
a second interleaf layer, wherein the lithium metal layer is positioned between the first interleaf layer and the second interleaf layer; and
a substrate positioned adjacent to the second interleaf layer.

2. An electrode precursor, comprising:
a first interleaf layer;
a second interleaf layer;
a lithium metal layer having a cross-section; and
an optional protective layer adjacent the lithium metal layer,
wherein the first and second interleaf layers are in conformal contact with the lithium metal layer and/or the optional protective layer, and wherein the first interleaf layer and the second interleaf layer surround a perimeter of the cross-section of the lithium metal layer and optional protective layer.

3. A method for cutting lithium metal, the method comprising:
positioning a layer of the lithium metal between a first interleaf layer and a second interleaf layer,
cutting the lithium metal with a blade to form a cut lithium metal piece having a cross-section, wherein the cutting step does not cut through the first interleaf layer, and
adhering the lithium metal to the first interleaf layer and/or the second interleaf layer such that the first interleaf layer and second interleaf layer surrounds a perimeter of the cross-section of the cut lithium metal piece.

4. (canceled)

5. The system of claim 1, wherein the asymmetric blade has a longitudinal axis perpendicular to the substrate, the longitudinal axis passing through the tip of the blade as shown in the cross-section of the blade, and wherein a first angle is formed between the first edge and the longitudinal axis.

6. The system of claim 1, wherein the asymmetric blade has a longitudinal axis perpendicular to the substrate, the longitudinal axis passing through the tip of the blade as shown in the cross-section of the blade, and wherein a second angle is formed between the second edge and the longitudinal axis.

7. The system of claim 5, wherein the first angle is less than or equal to 25 degrees.

8. The system of claim 6, wherein the second angle is less than or equal to 70 degrees.

9. The system of claim 6, wherein first angle and the second angle have a sum greater than or equal to 50 and less than or equal to 75.

10. The system of claim 1, wherein a thickness of the lithium metal layer is greater than or equal to 25 microns.

11. The system of claim 1, wherein a thickness of the first interleaf layer is less than or equal to 250 microns.

12. The system of claim 1, wherein a thickness of the first interleaf layer is greater than or equal to 0.5 microns.

13-14. (canceled)

15. The system of claim 1, wherein the first interleaf layer comprises a polymer.

16. (canceled)

17. The system of claim 1, wherein the second interleaf layer comprises a polymer.

18-21. (canceled)

22. The system of claim 1, further comprising an additional layer.

23. The system of claim 22, wherein the additional layer comprises a release layer.

24. The system of claim 22, wherein the additional layer comprises an electrode layer.

25. The method of claim 3, further comprising removing the first interleaf layer from the lithium metal.

26. The method of claim 3, further comprising lifting the lithium metal from the second interleaf layer.

27. The method of claim 26, wherein the lifting step is performed with a vacuum apparatus.

28. The method of claim 26, wherein the lifting step occurs within 30 seconds or less of the cutting step.

29-31. (canceled)
